(19) United States
(12) Patent Application Publication
(10) Pub. No.: US 2011/0041142 A1
(43) Pub. Date: Feb. 17, 2011

(54) ELECTRONIC APPARATUS HAVING MULTIPLE OPERATING SYSTEMS AND DATA MODIFICATION METHOD THEREOF

(75) Inventors: Szu-Wen Lin, Taipei County (TW); Tzu-Chieh Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ACER INCORPORATED, Taipei County (TW)

(21) Appl. No.: 12/635,073

(22) Filed: Dec. 10, 2009

(30) Foreign Application Priority Data
Aug. 13, 2009 (TW) 098127317

(51) Int. Cl. G06F 9/54

(52) U.S. Cl. 719/319

(57) ABSTRACT

This invention discloses an electronic apparatus having multiple operating systems and a data modification method thereof. The method comprises: a first operating system is executed on the electronic apparatus; an input data is received under the first operating system; then, under the first operating system, the input data is set into a second operating system; and, when the second operating system is executed on the electronic apparatus, the second operating system operates according to the input data. With the method, the electronic apparatus having multiple operating systems can be used in a more flexible manner, and the data modifying or data synchronization can be more conveniently performed.

### FIELD OF THE INVENTION

The present invention relates to an electronic apparatus having multiple operating systems and a data modification method thereof, and more particularly to a technique of using a first operating system to perform data modifying for a second operating system.

### BACKGROUND OF THE INVENTION

Generally speaking, an operating system can be considered as a combination of an operating system kernel and a software platform. The operating system kernel generally includes a memory management module, a process execution control module, a plurality of peripheral hardware device drive modules, a power management module, etc. One of the functions of the operating system kernel is to allow the software platform to be successfully running on electronic hardware via the operating system kernel. The software platform generally includes a window manager, an activity manager, a notification monitor, and an application terminator, and functions mainly to manage the running condition and display condition of different applications run thereon.

Currently, MICROSOFT Windows is adopted as the operating system (OS) by most computer users, while Linux operating system is chosen by other computer users. Meanwhile, with the popularization of various kinds of mobile Internet apparatus, such as smart phone, personal digital assistant (PDA) and the like, there are more and more electronic apparatuses that use an operating system other than the MICROSOFT Windows and the Linux operating system. Every operating system has its own advantages and disadvantages. Some of the currently available operating systems provide powerful functions but require more resources and the electronic apparatuses using these operating systems consume more electric power, while other operating systems require fewer resources but provide only limited functions.

Whether an operating system is good for use has a close relation with the number of application programs being supported by the operating system. Different operating systems are possibly developed at different time and accordingly, have different completeness in terms of their program developing environment. For example, the newest operating system developed for portable electronic apparatuses might provide the best effect of low power consumption while having less available application programs, which require more time to develop. As a result, users might feel inconvenient in operating the portable electronic apparatuses for some applications thereof. Therefore, it is desirable to work out a way for updating the operating system without scarifying the convenience in operating the application programs thereof.

### SUMMARY OF THE INVENTION

With regards to the aforementioned conventional problems, one of the objects of the present invention is to provide a data modification method applicable to an electronic apparatus having multiple operating systems, so that a user can use the electronic apparatus in a more flexible manner.

Another object of the present invention is to provide an electronic apparatus having multiple operating systems on which a data modification method is implemented, so that the electronic apparatus is more convenient for use.

To achieve the above and other objects, the data modification method according to the present invention applicable to an electronic apparatus having multiple operating systems includes the following steps: executing a first operating system on the electronic apparatus; receiving an input data under the first operating system; under the first operating system, setting the input data to fit a second operating system; and operating the second operating system based on the input data while the second operating system is executed on the electronic apparatus.

Herein, the second operating system is preferably stored on the electronic apparatus in a compressed file format.

Herein, the step of setting the input data into the second operating system further includes: decompressing the compressed file of the second operating system to obtain a second operating system data; modifying the second operating system data according to the input data; and compressing the modified second operating system data.

Herein, the first operating system is preferably a Windows-based operating system.

Herein, the second operating system is preferably an operating system using Linux kernel based operating system or an embedded operating system.

Herein, the input data includes a URL (uniform resource locator), a password, or an email account.

Herein, the step of receiving input data is preferably executed by an application program under operation of the first operating system.

Herein, the compressed file is preferably an image file format.

To achieve the above and still other objects, the electronic apparatus having multiple operating systems according to the present invention is provided. The electronic apparatus having multiple operating systems comprises a storage unit and a processing unit. A first operating system, a second operating system and an application program is stored in the storage unit. The first operating system and the application program are executed by the processing unit to receive an input data and set the input data into the second operating system under the first operating system. After the data modifying, the second operating system is executed by the processing unit according to the input data which has been set into the second operating system by the application program.

Herein, the second operating system is preferably stored in the storage unit in a compressed file format.

Herein, the application program is further executed by the processing unit to decompress the compressed file under the second operating system to obtain a second operating system data, then modify the second operating system data according to the input data, and compress the modified second operating system data.

Herein, the first operating system is preferably a Windows-based operating system.

Herein, the second operating system is preferably a Linux kernel based operating system or an embedded operating system.

Herein, the input data includes a URL (uniform resource locator), a password, or an email account.

Herein, the compressed file is preferably in an image file format.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a data modification method according to the present invention;

FIG. 2 is a flowchart showing the steps included in a data modification method according to an embodiment of the present invention; and

FIG. 3 is a block diagram of an electronic apparatus with multiple operating systems according to the present invention, on which the data modification method can be implemented.

### DETAILED DESCRIPTION OF THE PREFERRED EMBODIMENTS

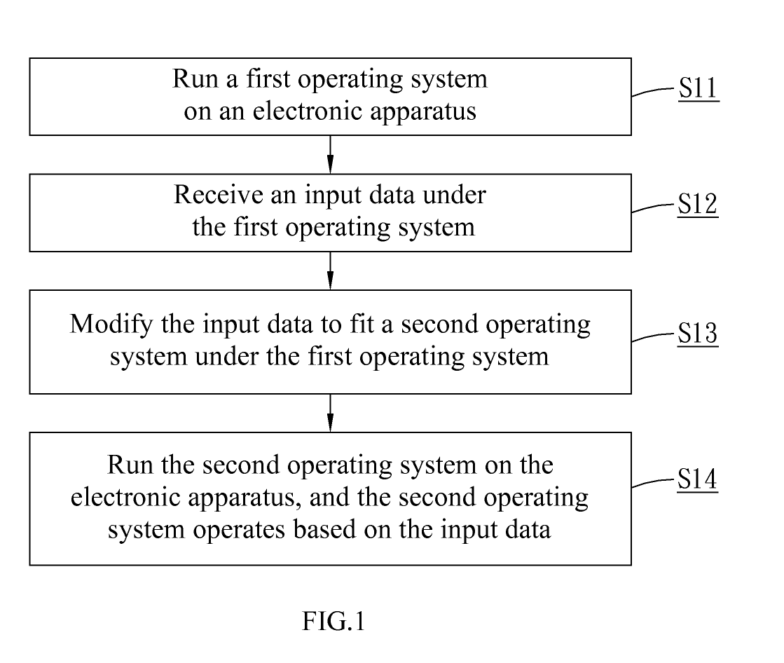

Please refer to FIG. 1, wherein a flowchart showing the steps included in a data modification method according to the present invention is shown. It is known different operating systems have respective merits and drawbacks. For instance, Windows-based OS (operating system) can support more application programs, more peripherals and more complete user experiences while it consumes more system resources, has a slower launch and shutdown speed and has relatively complicated user interface (UI). On the other hand, an operating system with Linux kernel advantageously consumes less resource and has a faster launch and shutdown speed while it supports less application programs and peripherals. Thus, an electronic apparatus having both Windows-based OS and an operating system with Linux kernel would allow a user to selectively start any one of the two different operating systems according to actual need. The data modification method according to the present invention as shown in FIG. 1 is applicable to the above-mentioned electronic apparatus with multiple operating systems, allowing a user to perform the data modifying for one operating system under the other operating system. The data modification method according to the present invention comprising the following steps: in step S11, a first operating system, such as the Windows-based OS, is executed on the electronic apparatus; in step S12, an input data is received under the first operating system; in step S13, the input data is set into a second operating system such as a Linux kernel based operating system or an embedded operating system under the first operating system, for example, the input data is wrote into an image file of the second operating system; in step S14, the second operating system is executed on the electronic apparatus according to the input data which has been set into the second operating system under the first operating system. Therefore, in the case an operating interface for a user to input data is not provided under the second operating system on the electronic apparatus, the user can follow the above-described steps to set data into the second operating system under the first operating system. Herein, the input data is preferably a parameter common to the first operating system and the second operating system, such as a URL (uniform resource locator), a password, an email account, a plurality of operating system modifying parameters, or a plurality of wireless communication modifying parameters, for example, WiFi security parameters.

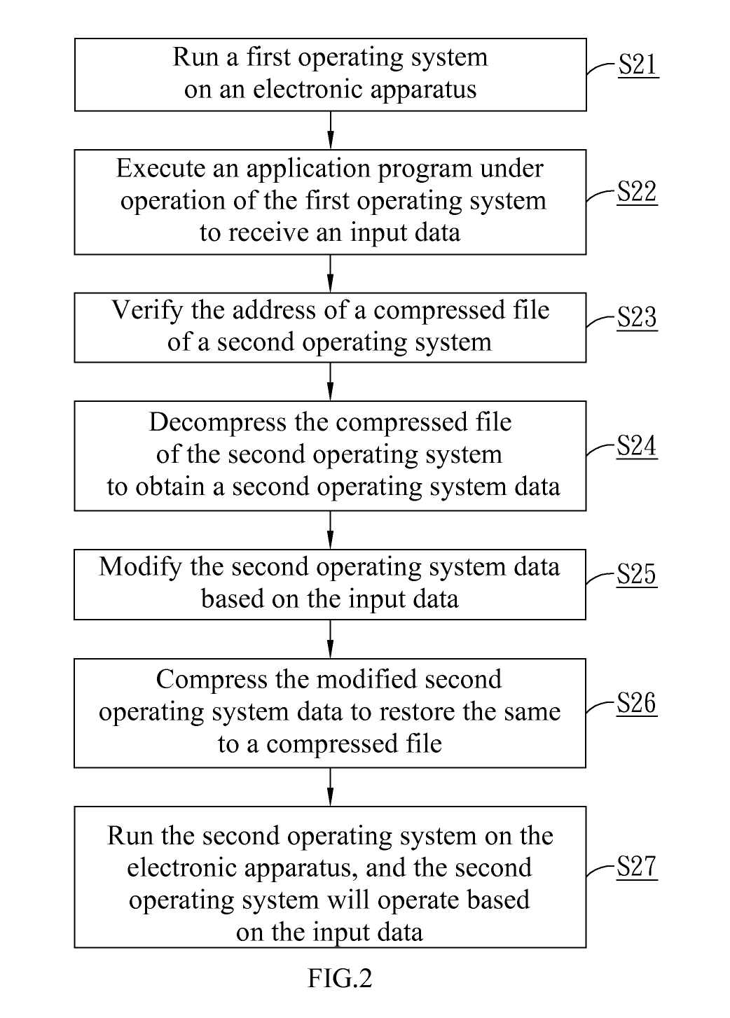

Please refer to FIG. 2, wherein a flowchart showing the steps included in a data modification method according to an embodiment of the present invention is shown, and comprising the following steps: in step S21, a first operating system is executed on the electronic apparatus; in step S22, an application program is executed under operation of the first operating system to receive an input data, such as a URL, a password, an email account, an operating system modifying parameter, or a wireless communication modifying parameter; in step S23, the address of a compressed file of a second operating system is verified, and the compressed file of the second operating system being preferably an image file format; in step S24, the compressed file of the second operating system is decompressed to obtain a second operating system data by the application program after inputting the data by a user; in step S25, the second operating system data is modified according to the input data by the application program; in step S26, the modified second operating system data is compressed to a compressed file by the application program after the data setting being completed; and in step S27, the second operating system is executed on the electronic apparatus according to the input data which has been set into the second operating system under the first operating system.

In the case a password is required for operating the second operating system, or a user's email account is required for running some specific application programs under the second operating system, or the data modifying is not easy for the user due to only a few interfaces are supported by the second operating system, a required modifying interface has not been developed by the manufacturer, or a relatively complicated data modifying manner is involved, the user can set the data under the first operating system using the above-described method. Or, when the user wishes to synchronize some specific data of the two operating systems, such as bookmarks, contacts data, or calendars, a data synchronizing function could also be designed and added in the above-mentioned application programs to synchronize the data to the second operating system in the compressed format under the first operating system. When the user launches the second operating system, the synchronized data is available for use and thereby largely increase the convenience in using the electronic apparatus.

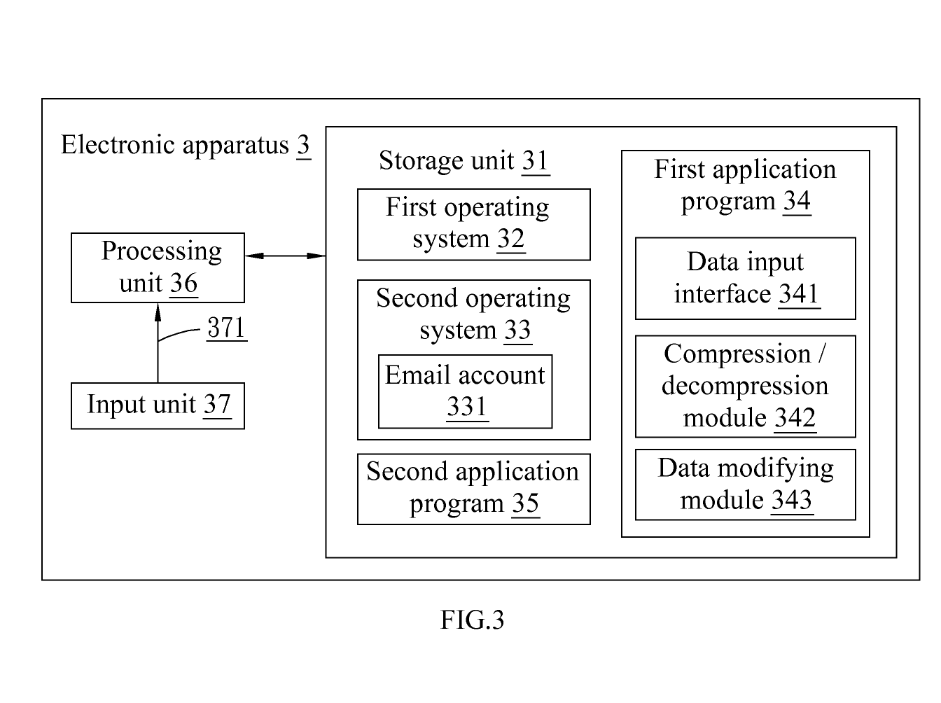

Please refer to FIG. 3, in which a block diagram of an electronic apparatus having multiple operating systems according to an embodiment of the present invention is shown. As shown, the electronic apparatus 3 comprises a storage unit 31, a processing unit 36, and an input unit 37. A first operating system 32, a second operating system 33, a first application program 34, and a second application program 35 are stored in the storage unit 31. The first and second operating systems 32, 33 and the first and second application programs 34, 35 can be executed by the processing unit 36. Herein, the first application program 34 comprising a data input interface 341, a compression/decompression module 342, and a data modifying module 343 can only be operated under the first operating system 32. The second application program 35 can only be operated under the second operating system 33. When the second application program 35 is executing, an email account 331 stored in the second operating system 33 is read to identify the user's identity. For example, when the second operating system 35 is run to execute Internet Email Access, Internet Calendar, etc., the email account 331 is required to log on the appropriate servers.

Since a modifying interface for a user to change the email account 331 is not provided by the second operating system 33, the electronic apparatus 3 provides a mechanism for the user to modify the email account 331 under the first operating system 32. That is, the data input interface 341 is generated by the first application program 34 under the first operating system 32 to receiving an input data 371 that is input by the user via the input unit 37. It can be observed from the file system of the first operating system 32 that the second operating system 33 is stored in the storage unit 31 in a compressed file format. Therefore, the compression/decompression module 342 of the first application program 34 decompresses the compressed file of the second operating system 33 to obtain document data of the second operating system 33 after receiving the input data 371. And then, the email account 331 in the document data of the second operating system 33 is modified by the data modifying module 343 according to the input data 371, and the compression/decompression module 342 compresses the document data of the second operating system 33 to restore the same to the compressed format. When the processing unit 36 executes the second operating system 33 at next time, the email account 331 in the second operating system 33 is that being modified under the first application program 34. Thus, the user can use the modified email account 331 under the second operating system 33.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A data modification method for operating system data applicable to on an electronic apparatus having multiple operating systems, comprising the steps of:
executing a first operating system on the electronic apparatus;
receiving an input data under the first operating system;
setting the input data into a second operating system under the first operating system; and
operating the second operating system based on the input data while the second operating system is executed on the electronic apparatus.

2. The data modification method as claimed in claim 1, wherein the second operating system is stored on the electronic apparatus in a compressed file format.

3. The data modification method as claimed in claim 2, wherein the step of setting the input data into the second operating system further includes the following steps:
decompressing the compressed file of the second operating system to obtain a second operating system data;
modifying the second operating system data according to the input data; and
compressing the modified second operating system data.

4. The data modification method as claimed in claim 1, wherein the first operating system is a Windows-based operating system.

5. The data modification method claimed in claim 1, wherein the second operating system is a Linux kernel based operating system or an embedded operating system.

6. The data modification method claimed in claim 1, wherein the input data includes a URL, a password, or an email account.

7. The data modification method claimed in claim 1, wherein the step of receiving the input data is executed by an application program under operation of the first operating system.

8. The data modification method as claimed in claim 7, wherein the application program further executes the following steps:
decompressing a compressed file of the second operating system to obtain a second operating system data;
modifying the second operating system data according to the input data; and
compressing the modified second operating system data.

9. The data modification method as claimed in claim 8, wherein the compressed file is in an image file format.

10. An electronic apparatus having multiple operating systems, comprising:
a storage unit capable of storing a first operating system, a second operating system, and an application program; and
a processing unit capable of executing the first operating system, and executing the application program under the first operating system to receive an input data and set the input data into the second operating system;
whereby when the processing unit executes the second operating system after the input data has been set into the second operating system, the second operating system is operated according to the input data.

11. The electronic apparatus as claimed in claim 10, wherein the second operating system is stored in the storage unit in a compressed file format.

12. The electronic apparatus as claimed in claim 11, wherein the compressed file is in an image file format.

13. The electronic apparatus as claimed in claim 11, wherein the processing unit further executes the application program to decompress the compressed file of the second operating system to obtain a second operating system data, then modify the second operating system data according to the input data, and compress the modified second operating system data.

14. The electronic apparatus as claimed in claim 10, wherein the first operating system is Windows-based operating system.

15. The electronic apparatus as claimed in claim 10, wherein the second operating system is a Linux kernel based operating system or an embedded operating system.

16. The electronic apparatus as claimed in claim 10, wherein the input data includes a URL, a password, and an email account.
